(19) United States
(12) Patent Application Publication
(10) Pub. No.: US 2008/0083122 A1
(43) Pub. Date: Apr. 10, 2008

(54) Tooling accessories for use while bow hunting

(76) Inventor: Charles D. McKenzie, Jackson, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 11/864,009

(22) Filed: Sep. 28, 2007

Related U.S. Application Data
(60) Provisional application No. 60/827,525, filed on Sep. 29, 2006.

(51) Int. Cl. B23D 51/10

(52) U.S. Cl. 30/517

(57) ABSTRACT

A hand saw for use while bow hunting comprises, in combination, a first arrow shaft, a second arrow shaft coaxially secured to a forward end of the first arrow shaft, a handle grip located at a rear end of the first arrow shaft, a blade adapter secured at a forward end of the second arrow shaft, and a saw blade secured to the adapter. Additionally a flashlight adapter is preferably provided which is attachable to a flashlight and can receive the blade adapter so that the saw blade can be selectively attached to either the arrow shafts or a flashlight.

### CROSS-REFERENCE TO RELATED APPLICATIONS

This application claims the benefit of U.S. Provisional Patent Application No. 60/827,525 filed on Sep. 29, 2006, the disclosure of which is expressly incorporated herein in its entirety by reference.

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to tooling accessories and, more particularly, to tooling accessories for use while bow hunting.

### BACKGROUND OF THE INVENTION

Hunting wild animals such as whitetail deer with a bow and arrows is a popular recreational activity. Hunting with a bow requires much skill due to the proximity that the hunter must be to the animal and the fact that the natural survival instincts and senses of the animal make it difficult to get within range. Successful techniques include quietly waiting in a tree or within heavy brush for an animal to pass by the hunter who is difficult to see, hear or smell.

It is rare that there is a perfect location for a bow hunter. For example, when a hunter sets a stand within a tree, there are often tree limbs that must be removed in order to be comfortably positioned on the stand or in order to get a lane for a clear shot. As a result, hunters must bring a tree saw of some kind or attempt to cut limbs with something other than a tree saw. Bringing a large tree saw is often not easily accomplished because the hunter is hiking to the location and already has many supplies that must be carried. A small tree saw can be ineffective if a cut must be made very far away from the tree stand. Using something other than a tree saw can be difficult, slow, and dangerous. Accordingly there is a need in the art for new tools for use while bow hunting.

### SUMMARY OF THE INVENTION

The present invention provides improved tools for use while bow hunting which overcome at least some of the above-noted problems of the related art. According to the present invention, a hand saw for use while bow hunting comprises, in combination, at least one arrow shaft, a handle grip located at a first end of the at least one arrow shaft, an adapter secured at a second end of the at least one arrow, and a saw blade secured to the adapter.

According another aspect of the present invention, a hand saw for use while bow hunting comprises, in combination, a first arrow shaft, a second arrow shaft coaxially secured to a forward end of the first arrow shaft, a handle grip located at a rear end of the first arrow shaft, an adapter secured at a forward end of the second arrow shaft, and a saw blade secured to the adapter.

According to yet another aspect of the present invention, a hand saw kit comprises, in combination, a handle grip for placement on a rear end of an arrow shaft, a flashlight adapter threadably attachable to a flashlight, a blade adapter selectively attachable to a forward end of an arrow shaft and the flashlight adapter, and a saw blade secured to the adapter.

From the foregoing disclosure and the following more detailed description of various preferred embodiments it will be apparent to those skilled in the art that the present invention provides a significant advance in improved tools for bow hunting. Particularly significant in this regard is the potential the invention affords for low cost, light weight, easily stowed tools for cutting light brush and tree limbs. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a side elevational view of a hand saw according to a preferred embodiment of the present invention, wherein a wood saw blade is connected to a pair of arrow shafts;

FIG. 2 is an enlarged exploded view of the hand saw of FIG. 1;

FIG. 3 is an enlarged view of a target tip adapter of the hand saw of FIGS. 1 and 2;

FIG. 4 is an enlarged view of the wood saw blade of the hand saw of FIGS. 1 and 2;

FIG. 5 is an enlarged view of a first threaded insert of the hand saw of FIGS. 1 and 2;

FIG. 6 is an enlarged view of a second threaded insert of the hand saw of FIGS. 1 and 2;

FIG. 7 is an enlarged view of another target tip adapter of the hand saw of FIGS. 1 and 2;

FIG. 8 is an side elevation view of a bow having an arrow holder securing the shafts of the hand saw of FIGS. 1 and 2;

FIG. 9 is an enlarged, fragmented view showing a variation of the hand saw of FIGS. 1 and 2 were there is an alternative locking device connecting the shafts;

FIG. 10 is a side elevational view of hand saw according to a second preferred embodiment of the present invention, wherein only a single shaft is utilized;

FIG. 11 is an enlarged exploded view of the hand saw of FIG. 10;

FIG. 12 is a side elevational view of hand saw according to a third preferred embodiment of the present invention, wherein a wood saw blade is connected to a flashlight; and

FIG. 13 is an enlarged, fragmented view of the hand saw of FIGS. 1 and 2 showing an adapter that connects the wood saw blade to the flashlight.

It should be understood that the appended drawings present a somewhat simplified representation of various preferred features that are illustrative of the basic principles of the inventions. The specific design features of the accessories as disclosed herein, including, for example, specific dimensions, orientations, locations, and shapes of the various components, will be determined in part by the particular intended application and use environment. All references to direction and position, unless otherwise indicated, refer to the orientation of the accessories illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the accessories disclosed herein. The following detailed discussion of various alternative and preferred embodiments will illustrate the general principles of the invention with reference to accessories for use when bow hunting. Other embodiments suitable for other applications will be apparent to those skilled in the art given the benefit of this disclosure.

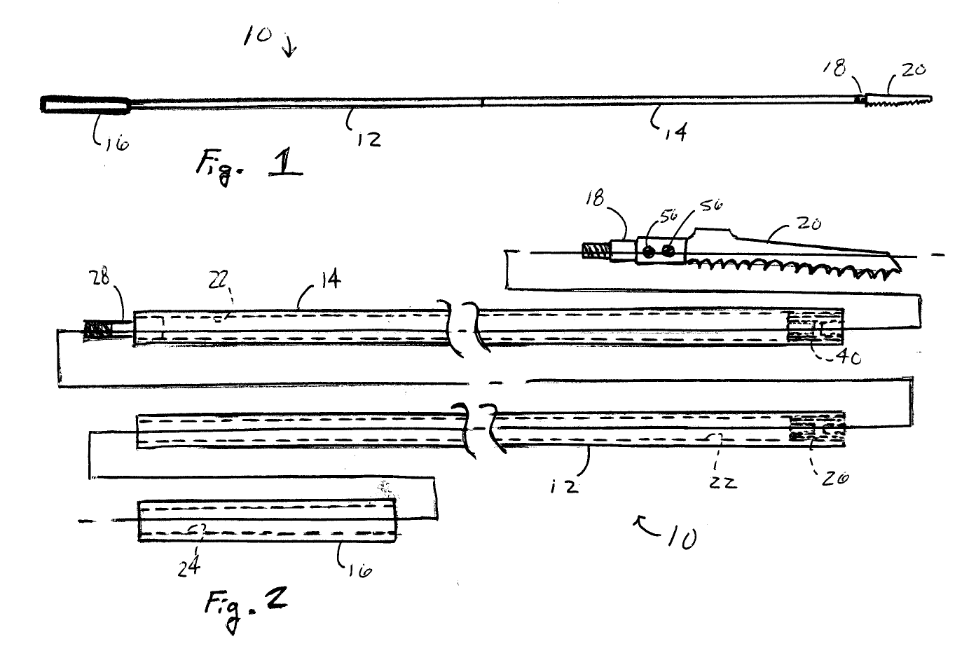

Referring now to the drawings, FIGS. 1 and 2 show a hand saw 10 according to a preferred embodiment of the present invention. The illustrated hand saw 10 includes a first or rear arrow shaft 12, a second or forward arrow shaft 14 coaxially secured to a forward end of the first arrow shaft 12, a handle grip 16 located at a rear end of the first arrow shaft 12, a blade adapter 18 secured to a forward end of the second arrow shaft 14, and a saw blade 20 secured to the blade adapter 18. A hunter can easily can easily construct the hand saw 10 with off the shelf arrow shafts 12, 14, stow the arrow shafts 12, 14 on arrow racks, and when needed connect the shafts 12, 14 and grasp the handle grip 16 to cut tree limbs or the like while bow hunting. The length of the two shafts 12, 14 enables limbs to be cut from relatively large distances.

The arrow shafts 12, 14 are elongate cylindrically-shaped shafts preferably having a length in the range of about 23 inches to about 33 inches and a diameter in the range of about 0.25 inches to about 0.50 inches. At least the ends of the arrow shafts 12, 14 have internal passages or recesses 22. The passage 22 can run the length of the shaft 12, 14 to form a hollow arrow shaft or can be only at the ends of the shafts 12, 14 to form a solid arrow shaft. The passages 22 are preferably circular in cross-section. The arrow shafts 12, 14 can comprise any suitable material such as, for example, a wood such as cedar, a metal such as an aluminum alloy, a composite material such as carbon fiber, or any combination such as a carbon fiber core with aluminum alloy jacket.

The first and second arrow shafts 12, 14 can be any suitable off-the-shelf arrow shafts that are commercially available. The illustrated first arrow shaft 12 is an Easton 2613 arrow shaft comprising an aluminum allow and having a length of about 30.5 inches, a diameter of about 0.415 inches, and an internal diameter of about 0.385 inches. The illustrated second arrow shaft 14 is an Easton 2314 arrow shaft comprising an aluminum allow and having a length of about 30 inches, a diameter of about 0.360 inches, and an internal diameter of about 0.330 inches. The illustrated first and second arrow shafts are available from Easton Technical Products of Salt Lake City, Utah. It is noted that any other suitable commercially-available arrow shafts 12, 14 can alternatively be utilized.

As best shown in FIG. 2, the illustrated handle grip 16 is tubular shaped. The handle grip 16 is preferably formed of a resiliently flexible material so that it provides a slip resistant surface when grasped by the user and so that it can be secured to the first arrow shaft 12 with a friction or interference fit. The handle grip 16 can comprise any suitable material such as, for example, elastomer, rubber, plastic, or the like. The handle grip 16 preferably has an internal passage 24 with internal diameter smaller than the outer diameter of the first arrow shaft 12. The illustrated handle grip is a rubber hose having a length of about 7 inches and an outer diameter of about 0.375 inches. It is noted that any other suitable form of hand grip can alternatively be utilized.

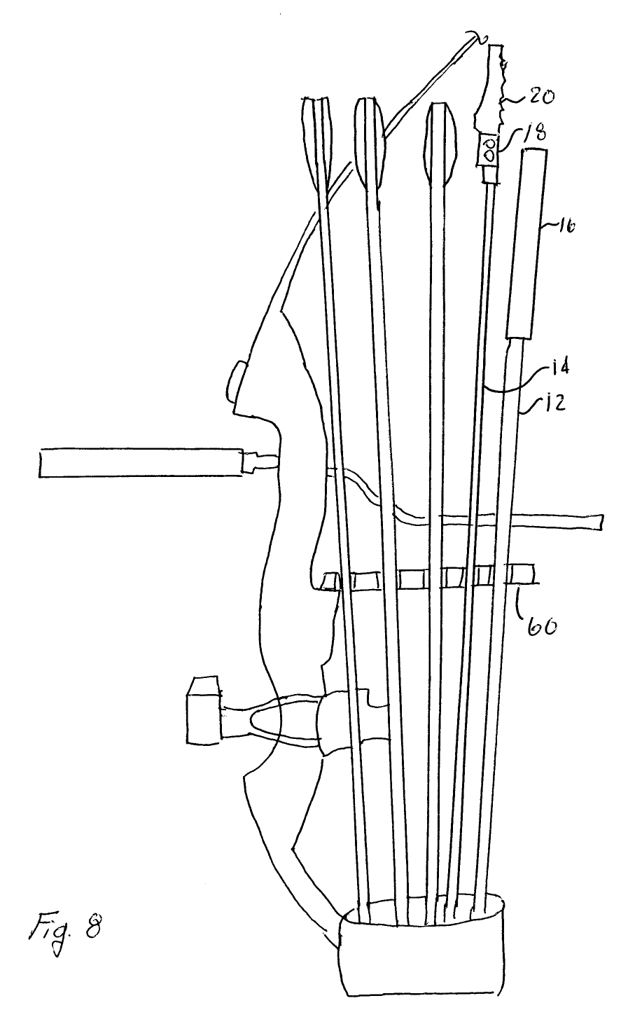

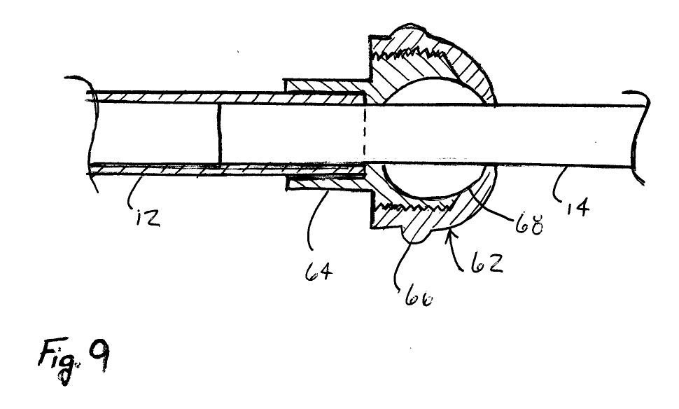

The illustrated first and second arrow shafts 12, 14 are removably secured together by a thread insert 26 secured to the forward end of the first arrow shaft 12 and a tip adapter 28 secured the rearward end of the second arrow shaft 14. As best shown in FIG. 5, the illustrated thread insert 26 has a cylindrically-shaped body 30 having an outer diameter sized for insertion into the passage 22 of the first arrow shaft 12. The thread insert 26 can be secured within the passage 22 in any suitable manner such as, for example, a friction fit, adhesive, or the like. The body 30 has internal threads 32 sized and shaped for cooperating with the tip adapter 28. The illustrated thread insert 26 has a length of about 0.840 inches, an outside diameter of about 0.385 inches, and size 8-32 internal threads. As best shown in FIG. 7, the illustrated tip adapter 28 has a cylindrically shaped body 34 having an outside diameter sized for insertion within the passage 22 of the second arrow shaft 14 and a shaft 36 coaxially extending from the body 34. The shaft is provided with an external thread 38 sized and shaped for cooperating with the internal thread 32 of the thread insert 26. The tip adapter 28 can be secured within the passage 22 in any suitable manner such as, for example, a friction fit, adhesive, or the like. The first and second shafts 12, 14 can be easily connected and disconnected by threading the tip adapter shaft 36 into and out of the thread insert 26. It is noted that the first and second arrow shafts 12, 14 can alternatively be connected in any other suitable manner.

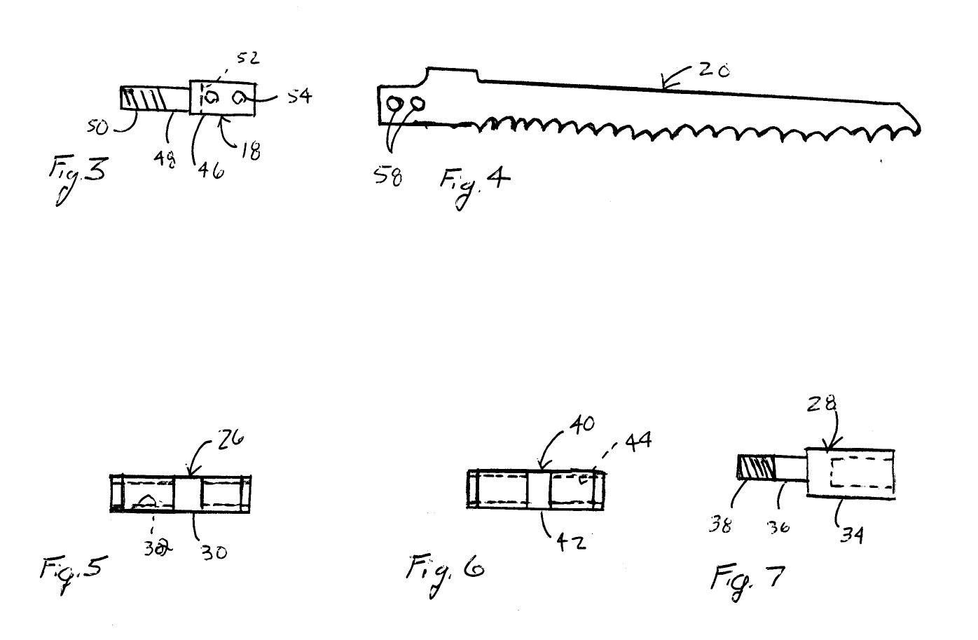

The saw blade 20 can be removably connected to the second arrow shaft 12 by a thread insert 40 secured to the forward end of the second arrow shaft 14 and the blade adapter 18 secured to the rearward end of the saw blade 20. As best shown in FIG. 6, the illustrated thread insert 40 has a cylindrically-shaped body 42 having an outer diameter sized for insertion into the passage 22 of the second arrow shaft 14. The thread insert 40 can be secured within the passage 22 in any suitable manner such as, for example, a friction fit, adhesive, or the like. The body 42 has internal threads 44 sized and shaped for cooperating with the blade adapter 18. The illustrated thread insert 40 has a length of about 0.840 inches, an outside diameter of about 0.360 inches, and size 8-32 internal threads. As best shown in FIG. 3, the illustrated blade adapter 18 has a cylindrically shaped body 46 sized and shaped for attachment of the saw blade 20 and a shaft 48 coaxially extending from the body 46. The shaft 46 is provided with an external thread 50 sized and shaped for cooperating with the internal thread 44 of the thread insert 40. The illustrated blade adapter 18 has a body length of bout 0.700 inches and a body diameter of about 0.330 inches, a shaft length of about 0.75 inches, a shaft diameter of about 0.202 inches, an external thread length of about 0.375 and an external thread size of 8-32. The blade adapter 18 can be easily connected and disconnected to the second arrow shaft 14 by threading the blade adapter shaft 48 into and out of the thread insert 40. It is noted that the blade adapter 18 can alternatively be removably connected to the second arrow shaft 14 in any other suitable manner.

The blade adapter body 46 is adapted for attachment of the saw blade 20 and preferably removable attachment of the saw blade 20 so that the user can easily replace the saw blade 20. The illustrated body 46 includes a longitudinally extending slot for receiving the rear end of the saw blade 20. The illustrated slot 52 is about 0.5 inches deep and extends the full height of the body 46. The illustrated body 46 also includes a pair of longitudinally spaced-apart holes 54 laterally extending through the slot 52. The holes 54 are configured to cooperate with a pair of screws 56 and openings 58 in the saw blade 20 to removably secure the saw blade 20 to the blade adapter 18. Preferably, the holes 54 are clearance openings on one side of the slot 52 and threaded on the other side of the slot 52. The illustrated holes 54 are spaced apart by a distance of 0.25 inches to match the standard spacing of the saw blade 20. The illustrated screws 56 are 6-32×0.75 inch long self locking screws but any other suitable screws can alternatively be utilized. It is noted that the saw blade 20 can alternatively be secured to the blade adapter 18 in any other suitable manner such as, for example, welding, rivets, adhesive, snap lock, clamp, bayonet connection, or the like.

As best shown in FIG. 4, the illustrated saw blade 20 is a standard off-the shelf very-coarse wood saw blade having a pair of longitudinally spaced-apart attachment openings 58. The illustrated saw blade 20 has a length of about 6 inches and a height that varies from about 0.75 inches to about 1 inch. It is noted that any other suitable saw blade can alternatively be utilized.

Constructed in this manner, the illustrated hand saw can easily be assembled except for connecting the first and second arrow shafts 12, 14. As best shown in FIG. 8, the arrow shafts 12, 14 of hand saw 10 can then be easily stowed along with other arrows on an arrow rack 60 so that the hand saw 10 is easily transported and readily accessible for use. When needed, a hunter can easily can easily remove the arrow shafts 12,14 from the rack 60, connect the arrow shafts 12, 14 by screwing the tip adapter 28 into the thread insert 26. The hunter then simply grasps the handle grip 16 to cut tree limbs or the like. When finished, the process is reversed to stow the hand saw.

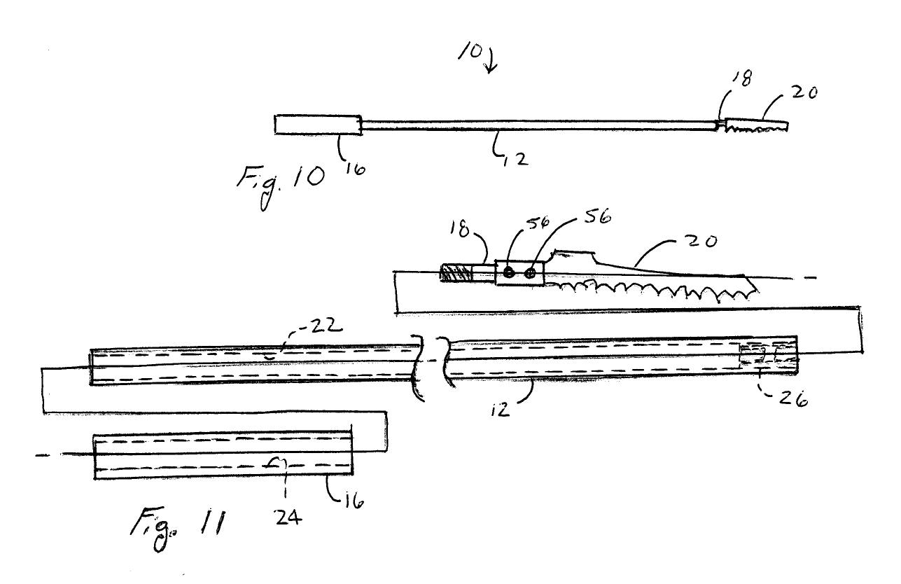

FIG. 9 illustrates an alternative removable connection between the first and second arrow shafts 12, 14 in the form of a twist lock type locking device 62. The twist lock type locking device 62 illustrates that any other suitable connection can alternatively be utilized between the first and second arrow shafts 12, 14. The illustrated device 62 includes a gripping member 64 secured to the forward end of the first arrow shaft 12, a compressing member 66 threadably secured to the gripping member 64, and a bushing located between gripping member 64 and the compressing member 66. The gripping member is bonded or otherwise secured to the forward end of the first arrow shaft 12. The members form a central passage 70 through which the rear end of the second arrow shaft extends and passes into the internal passage 22 of the first arrow shaft 12. When the compressing member 66 is turned clockwise, the second arrow shaft 14 is locked to the first arrow shaft 12. When the compressing member is turned counterclockwise, the second arrow shaft 14 is unlocked from the first arrow shaft 12. The bushing 68 is preferably split to prevent crushing of the second arrow shaft 14 and preferably comprises Teflon. It is noted that the twist lock type locking device 62 can alternatively take any other suitable form.

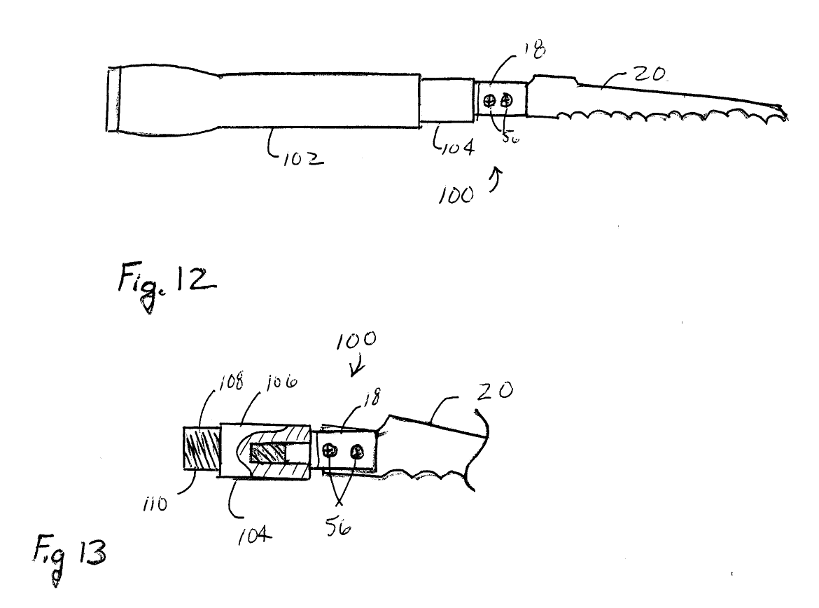

FIGS. 10 and 11 show the hand saw 10 configured so that the second arrow shaft is not utilized. In this configuration, the blade adapter 18 is removably secured directly to the forward end of the first arrow shaft 12. This configuration of the hand saw 10 illustrates that other quantities of arrow shafts 12, 14 can be utilized depending on whether it is desired for the hand saw 10 to be shorter or longer.

FIGS. 12 and 13 show a hand saw 100 according to a second preferred embodiment of the present invention. The hand saw 10 includes a mini flashlight 102, a flashlight adapter 104, and the blade adapter 18 and the saw blade 20 described above so that the saw blade 20 is removably secured to the end of a the mini flashlight 102. Constructed in this manner, a hunter can easily grasp the flashlight 102 to cut tree limbs or the like while bow hunting. The length and thickness of the flashlight 102 enables relatively large diameter limbs to be cut from relatively small distances because more force can be applied to the saw blade 20.

The illustrated flash light is a Mini Maglite AA available from Mag Instrument Inc. of Ontario, Calif. It is noted, however, that the flashlight 102 can alternatively be any other suitable flashlight. The illustrated flashlight adapter 104 has a cylindrically shaped body 106 sized and shaped for attachment of the blade adapter 18 and a shaft 108 coaxially extending from the body 106. The shaft 108 is provided with an external thread 110 sized and shaped for cooperating with an internal thread of the flashlight 102. The illustrated flashlight adapter 104 has a body length of bout 1 inches and a body diameter of about 0.75 inches, and a shaft external thread size of ⅝-32. The flashlight adapter 104 can be easily connected and disconnected to the flashlight 102 by threading the flashlight adapter shaft 108 into and out of the flashlight 102. It is noted that the flashlight adapter 104 can alternatively be removably connected to the flashlight 102 in any other suitable manner. In use, the hunter simply unscrews a cap from the flashlight 102 and screws the adapter 104 in its place to secure the saw blade 20 to the flashlight 104.

It is apparent from the foregoing disclosure that the above described accessories can be provided in any combination. Preferably, a kit includes at least the wood saw blade 20, the blade adapter 18 for attachment to an arrow shaft 12, 14, the handle grip 16, and the flashlight adapter 104 for attachment to the flashlight 102. It is noted that some of these components can be eliminated form the kit if desired. It is also noted that one or more additional components can be included in the kit if desired such as, for example, the first and second arrow shafts 12, 14, the thread inserts 26, 40, and/or the tip adapter 28. Additionally, the kit can include a pouch so that the arrow shafts 12, 14 can be stored on the bow and any remaining components can be readily available from the pouch to utilize either the flashlight 102 or the arrow shafts 12,14 as a handle for the saw blade 20.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A hand saw for use while bow hunting, said hand saw comprising, in combination:
at least one arrow shaft;
a handle grip located at a first end of the at least one arrow shaft;
an adapter secured at a second end of the at least one arrow; and
a saw blade secured to the adapter.

2. The hand saw according to claim 1, wherein the handle grip is a flexible tube receiving the first end therein.

3. The hand saw according to claim 1, wherein the adapter has a threaded shaft for attachment to the second end.

4. The hand saw according to claim 1, wherein the saw blade is removably secured to the adapter.

5. The hand saw according to claim 14, wherein the saw blade is removably secured to the adapter with at least one screw.

6. The hand saw according to claim 1, wherein there are two arrow shafts secured together.

7. The hand saw according to claim 1, wherein the two arrow shafts are secured together by a tip adapter having a cylindrical body for insertion into one of the two arrow shafts and a threaded shaft for insertion into the other of the two arrow shafts.

8. The hand saw according to claim 1, wherein the two arrow shafts are secured together by a twist-lock device.

9. The hand saw according to claim 1, wherein an internal passage is formed in each end of the at least one arrow shaft.

10. The hand saw according to claim 9, wherein a cylindrically shaped insert having at least one internally threaded end is secured in the passage at the second end of the at least one arrow shaft, and wherein the adapter has a threaded shaft threadibly secured to the insert to secure the adapter to the at least one arrow shaft.

11. A hand saw for use while bow hunting, said hand saw comprising, in combination:
a first arrow shaft;
a second arrow shaft coaxially secured to a forward end of the first arrow shaft;
a handle grip located at a rear end of the first arrow shaft;
an adapter secured at a forward end of the second arrow shaft; and
a saw blade secured to the adapter.

12. The hand saw according to claim 11, wherein the handle grip is a flexible tube receiving the rear end of the first arrow shaft therein.

13. The hand saw according to claim 11, wherein the adapter has a threaded shaft for attachment to the forward end of the second arrow shaft.

14. The hand saw according to claim 11, wherein the saw blade is removably secured to the adapter.

15. The hand saw according to claim 14, wherein the saw blade is removably secured to the adapter with at least one screw.

16. The hand saw according to claim 11, wherein the arrow shafts are secured together by a tip adapter having a cylindrical body for insertion into one of the two arrow shafts and a threaded shaft for insertion into the other of the two arrow shafts.

17. The hand saw according to claim 11, wherein the arrow shafts are secured together by a twist-lock device.

18. The hand saw according to claim 11, wherein an internal passage is formed in each end of each of the two arrow shafts.

19. The hand saw according to claim 18, wherein a cylindrically shaped insert having at least one internally threaded end is located in the passage at the forward end of the second arrow shaft, and wherein the adapter has a threaded shaft threadibly secured to the insert to secure the adapter to the second arrow shaft.

20. A hand saw kit, said hand saw kit comprising, in combination:
a handle grip for placement on a rear end of an arrow shaft;
a flashlight adapter threadably attachable to a flashlight;
a blade adapter selectively attachable to a forward end of an arrow shaft and the flashlight adapter; and
a saw blade secured to the adapter.
